(19) United States
(12) Patent Application Publication
(10) Pub. No.: US 2005/0267801 A1
(43) Pub. Date: Dec. 1, 2005

(54) Business method for providing advertising information on point-of-sale product packaging

(76) Inventor: Earl Kaufman, Phoenix, AZ (US)

Correspondence Address: THE LAW OFFICE OF RICHARD S ERBE, P.O. BOX 418, 5380 SENECA PLACE, SIMI VALLEY, CA, 93062, US

(21) Appl. No.: 10/856,525

(22) Filed: May 28, 2004

(51) Int. Cl. G06F 17/60

(52) U.S. Cl. 705/14

(57) ABSTRACT

In an agreement between a point-of-sale product packaging provider and a merchant the merchant agrees to accept and use product packaging bearing advertising information in connection with sales of the merchant's products to its customers. Shopping bags may be pre-printed with a manufacturer's logo or other advertising messages. Another agreement between the point-of-sale product packaging provider and an advertising purchaser specifies that the advertising purchaser will compensate the provider for the provider's applying advertising to the point-of-sale product packaging and supplying it for the merchant's use. The point-of-sale packaging can thus be provided to the merchant at a cost less than that the merchant would ordinarily pay, subsidized at least in part by the advertising purchaser's paying to have its advertising messages placed on the packaging and delivered to the merchant's customers.

### BACKGROUND OF THE INVENTION

The invention relates generally to business methods for communicating advertising messages to consumers. More specifically, the invention provides a business method for providing shopping bags or other point-of-sale product packaging bearing advertising messages to a merchant, who then passes the message-bearing packaging on to its customers as packaging for purchases the customers make from the merchant.

Goods sold to customers by merchants are frequently placed into some kind of packaging at the place where the goods are sold. Any of a wide range of products may be placed into shopping bags, for example, at cash registers where the merchant's customers pay for the goods at the merchant's retail locations.

Such shopping bags and packaging are usually purchased by the merchants, but the cost of the bags is usually not charged directly to the merchant's customers, being instead incorporated indirectly into the merchant's overall prices. Sometimes the merchant's logo or other advertising information is applied to the bags. This serves to identify the merchant with the goods in the mind of the customers, and can thus be thought to deliver some level of value to the merchant as a form of advertising. This value, though, is not believed to equal the entire cost of purchasing the point-of-sale packaging, and the cost of that packaging is thus regarded as a significant cost to the merchant and a detriment to its overall business.

At the same time, a wide variety of advertisers continually seeks to purchase and deliver advertising messages to customers through an almost limitless array of advertising channels. Such advertising purchasers would be happy to pay to have their advertising messages delivered to customers, particularly if those customers could be identified with reasonable specificity, and the quantity and timing of the messages' delivery specified as well with reasonable certainty.

It would be desirable, therefore, if a novel business arrangement could be devised whereby a merchant's costs of acquiring shopping bags and other packaging could be reduced, while at the same time satisfying an advertiser's desire to have its messages delivered to a well-identified group of prospective customers—specifically, existing customers of another pre-selected merchant.

### SUMMARY OF THE INVENTION

A preferred embodiment of the invention provides a business method in which an agreement is created between a point-of-sale product packaging provider and a merchant. Under this agreement, the merchant agrees to accept and use point-of-sale product packaging bearing advertising information in connection with sales of products by the merchant to the merchant's customers. The point-of-sale product packaging may be, for example, shopping bags pre-printed with another manufacturer's logo or other advertising messages related to goods or services in addition to or other than those sold by the merchant.

Another agreement is created between the point-of-sale product packaging provider and an advertising purchaser. This agreement specifies that the advertising purchaser will compensate the provider for the provider's arranging to have the advertising purchaser's information applied to the point-of-sale product packaging supplied to the merchant and used in connection with the merchant's sales of products to its customers.

In this way, the point-of-sale packaging can be provided to the merchant at a cost less than that the merchant would ordinarily pay, subsidized at least in part by the fee paid by the advertising purchaser to have its advertising messages placed on the packaging and delivered to the merchant's customers.

### BRIEF DESCRIPTION OF THE DRAWINGS

FIG. 1 is a schematic drawing illustrating a preferred embodiment of a business method for communicating advertising messages to a merchant's customers using message-bearing point-of-sale product packaging.

FIG. 2 is a schematic drawing illustrating a specific embodiment in which a soft drink manufacturer enters into an arrangement for the purpose of delivering messages concerning its soft drinks to customers of a general retailer merchant.

### DESCRIPTION OF THE PREFERRED EMBODIMENTS

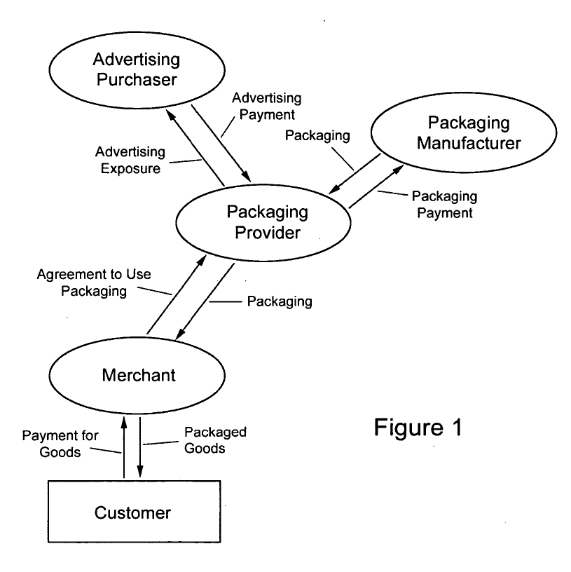

A business method that embodies the invention is depicted in FIG. 1, which illustrates a web of relationships between several business entities.

These entities include an advertising purchaser who is or who represents a business entity that markets goods or services that the advertising purchaser would like to see advertised to consumers who purchase goods from another business entity. The advertising purchaser may itself be a manufacturer, seller, or provider of goods or services, or it may be another entity such as an advertising agency that purchases advertising on behalf of another entity.

The advertising purchaser enters into a first agreement with a packaging provider, who serves as an intermediary between the advertising purchaser and a merchant pursuant to a second agreement between the packaging provider and the merchant. The merchant sells goods or services to its own customers, to whom the advertising purchaser would like to deliver its own advertising messages.

As FIG. 1 illustrates, the first agreement is formed between the advertising purchaser and the packaging provider. This agreement provides that the advertising purchaser will pay or otherwise compensate the packaging provider in return for the packaging provider's securing advertising exposure to the merchant's customers for the benefit of the advertising purchaser.

The second agreement, between the packaging provider and the merchant, specifies that the packaging provider will provide point-of-sale product packaging to the merchant in exchange for the merchant's agreement to place its goods in the packaging when the merchant's goods are sold and delivered to its customers.

The point-of-sale product packaging that the packaging provider provides to the merchant is imprinted with or otherwise carries advertising information related to the products or services sold by or otherwise of interest to the advertising purchaser. These goods or services may or may not be related to the goods or services sold by the merchant. The advertising purchaser benefits from this arrangement in that its advertising messages are communicated to the merchant's customers when the point-of-sale product packaging is delivered to the customers in connection with sales of the merchant's goods. The merchant benefits by having point-of-sale packaging, which it would otherwise have to purchase at its own expense, delivered to it either free-of-charge or at a substantial discount to what it would normally have to pay.

The packaging provider might manufacture the point-of-sale product packaging itself, or the packaging provider might purchase the packaging from an independent packaging manufacturer, as FIG. 1 suggests.

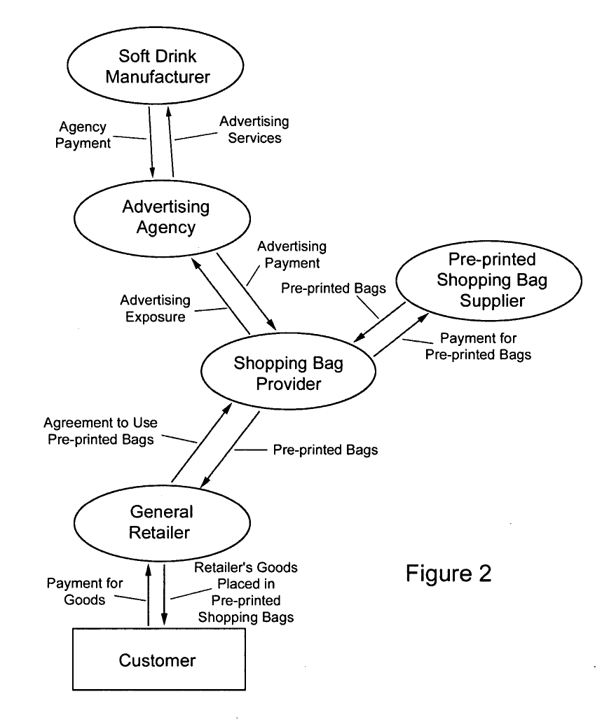

A more specific example will further illustrate the main features of the invention. FIG. 2 illustrates an arrangement involving a soft drink manufacturer that wishes to have advertising related to its soft drinks to customers of a general retailer. The retailer might sell to its customers a wide range of products, possibly including food items, clothing, household goods, other such goods. Those goods would then normally be placed into shopping bags at cash registers at the time those goods are delivered to the customers at the retailer's store locations.

A shopping bag provider negotiates an agreement with the retailer whereby the provider agrees to provide to the retailer attractive, high-quality pre-printed point-of-sale merchandise packaging in the form of shopping bags pre-printed with advertising messages. In a preferred embodiment, these bags would be provided to the retailer at no charge, in others at a significant discount to what the retailer would normally have to pay to acquire equivalent packaging. The retailer agrees, on its part, to accept the bags, and to use them as point-of-sale packaging in connection with the retailer's sales of its merchandise to its customers.

The shopping bag provider then negotiates an agreement with the soft drink manufacturer pursuant to which the soft drink manufacturer agrees to pay a fee to the shopping bag provider and in exchange for which the shopping bag provider agrees to secure and provide to the retailer a pre-specified quantity of shopping bags pre-printed with the manufacturer's logo, brand identifiers, or other advertising information related to the manufacturer's soft drinks.

The shopping bag provider profits from the difference between the advertising payment it receives from the drink manufacturer (or its advertising agency) and its own cost of acquiring the preprinted bags from the packaging manufacturer. The packaging provider thus serves as sort of a broker or intermediary between the advertising purchaser and the merchant in an arrangement in which the merchant acquires point-of-sale product packaging (pre-printed shopping bags) at a discount, with the advertising purchaser acting as a sponsor to subsidize the cost of the packaging in exchange for the placement and delivery of its advertising information.

In the embodiment illustrated in FIG. 2, the shopping bag provider interacts with the soft drink manufacturer through an advertising agency, but in other embodiments this relationship might be direct. In FIG. 2, moreover, the shopping bag provider is illustrated as acquiring pre-printed bags from an independent bag supplier, but in other embodiments the shopping bag provider might itself manufacture and imprint the bags with the soft drink manufacturer's advertising information.

It may be to the bag provider's advantage to negotiate the agreement between itself and the general retailer first, before it negotiates with the soft drink manufacturer. The agreement between the provider and the retailer can specify packaging quantities and time periods during which those bags will be used by the retailer. These parameters can then be incorporated into the agreement between the provider and the drinks manufacturer, with the manufacturer's payment to the provider based on a firm commitment by a pre-identified retailer to distribute a certain quantity of packaging bearing the manufacturer's information to a relatively well-defined customer group (the retailer's customers) within a predetermined time period.

In the example of FIG. 2, the point-of-sale product packaging is in the form of shopping bags. The shopping bags are “point-of-sale” packaging in that the goods are not shipped from the various goods' manufacturers to the retailer in the packaging. The goods are instead placed inside the packaging at the point-of-sale, e.g., at cash registers at the retail locations at which the goods are sold and delivered to the retailer's customers. The product packaging is “general purpose” packaging in that it need not be specifically adapted or intended for any specific goods of the merchant. Shopping bags are such general purpose packaging, in that a very wide variety of goods are frequently packaged in such bags. Pre-printed drinks cups, on the other hand, would be better described as special purpose packaging, in that they are intended for the packaging and delivery of a much more narrow class of goods (beverages to be consumed immediately upon their purchase).

Shopping bags are used by many retailers for a very wide variety of goods. Other point-of-sale packaging might be used, though, as well. Such packaging might include boxes, cartons, or other carriers or containers in which goods would be placed at the time of their purchase. Advertising messages might be printed on or otherwise applied to any such packaging.

In preferred embodiments, each of the point-of-sale product packaging provider, the merchant, and the advertising purchaser is a separate business entity. This means that none of these entities is a parent, subsidiary, corporate affiliate, or significant partial owner of any of the other entities, nor is any of the entities under the effective corporate or business control of any of the others. This means that the packaging provider will generally be free to negotiate advertising agreements with a wide variety of advertising purchasers, and packaging supply agreements with a wide variety of merchants. It will frequently be the case, though, that the advertising agreement between the advertising purchaser and the packaging provider will specify the identity of the merchant, as the advertising purchaser will want to know the audience to which its advertising messages will be delivered, i.e., who are the merchant's usual customers. Similarly, the packaging supply agreement between the provider and the merchant may well specify the identity of the advertising purchaser and the content of the advertising messages, as the merchant will not want to deliver messages it regards as unacceptable to customers at its own retail locations.

Although the various payments between the entities taking part in these transactions will ordinarily be in cash, other compensation, including barter of goods or services, discounts, debt set-offs, and the like may also serve as compensation or payment in various arrangements that embody the invention.

Embodiments of the invention have been described above as illustrative examples. Various changes, modifications, substitutes and additions may be made to these arrangements, though, without departing from the invention's principles. The scope of the invention should not be limited to the specific embodiments identified above, therefore, but rather by reference to the appended claims, along with the full scope of equivalents to which those claims are legally entitled.

1. A business method comprising:
creating an agreement between a point-of-sale product packaging provider and a merchant, wherein the agreement between the point-of-sale product packaging provider and the merchant provides that the point-of-sale product packaging provider will provide to the merchant point-of-sale product packaging bearing advertising information and that the merchant will dispense the point-of-sale product packaging bearing the advertising information to customers of the merchant in association with purchases by customers from the merchant;
creating an agreement between an advertising purchaser and the point-of-sale product packaging provider, wherein the agreement between the advertising purchaser and the point-of-sale product packaging provider provides that the point-of-sale product packaging provider will arrange to have the advertising information applied to the point-of-sale product packaging and then to have the point-of-sale product packaging delivered to the merchant for dispensation to the merchant's customers, in exchange for compensation paid by the advertising purchaser to the point-of-sale product packaging provider; and
dispensing the point-of-sale product packaging bearing the advertising information to the customers of the merchant in association with purchases by the customers from the merchant.

2. The business method of claim 1, and further comprising:
before creating the agreement between the advertising purchaser and the point-of-sale product packaging provider, creating the agreement between the point-of-sale product packaging provider and the merchant, and wherein the agreement between the point-of-sale product packaging provider and the merchant specifies that the merchant will dispense to the customers, in association with purchases by the customers from the merchant, at least a pre-specified minimum quantity of the point-of-sale product packaging bearing the advertising information.

3. The business method of claim 1, and further comprising:
creating an agreement between the point-of-sale product packaging provider and a point-of-sale product packaging manufacturer, wherein the point-of-sale product packaging manufacturer agrees to manufacture the point-of-sale product packaging bearing the advertising information and to supply it to the point-of-sale product packaging provider in exchange for compensation from the point-of-sale product packaging provider to the point-of-sale product packaging manufacturer.

4. The business method of claim 1, wherein the point-of-sale product packaging includes general purpose containers bearing the advertising information and into which the customer's purchases are placed when the customers purchase goods from the merchant.

5. The business method of claim 4, wherein the general purpose point-of-sale containers include shopping bags bearing the advertising information, and wherein the customer's purchases are placed inside the shopping bags at the time of their purchase from the merchant.

6. The business method of claim 1, wherein each of the point-of-sale product packaging provider, the merchant, and the advertising purchaser is a separate business entity independent of the other two.

7. The business method of claim 1, wherein the agreement between the point-of-sale product packaging provider and the merchant specifies at least one of the identity of the advertising purchaser and the content of the advertising message.

8. The business method of claim 1, wherein the agreement between the point-of-sale product packaging provider and the advertising purchaser specifies the identity of the merchant.

9. A business method comprising:
creating a shopping bag supply agreement with a merchant under which the merchant will be supplied with a predetermined quantity of shopping bags bearing advertising messages related to the products of an adverting purchaser, wherein the bags will be supplied to the merchant at a cost that is at least substantially reduced in comparison with the cost the merchant would normally pay for the bags; and
creating a advertising agreement with the advertising purchaser under which the advertising messages will be borne by the shopping bags supplied to the merchant;
wherein the merchant and the advertising purchaser are independent entities, and wherein there is no agreement for supply of the shopping bags directly between the merchant and the advertising purchaser.
